(19) United States
(12) Patent Application Publication
(10) Pub. No.: US 2006/0093726 A1
(43) Pub. Date: May 4, 2006

(54) Feed supplement and method of making thereof

(75) Inventors: Gerald M. Bachmeier, Morris, MN (US); Daniel L. Anderson, Starbuck, MN (US)

Correspondence Address: IPLM GROUP, P.A., POST OFFICE BOX 18455, MINNEAPOLIS, MN, 55418, US

(73) Assignee: Diversified Energy Company, LLC

(21) Appl. No.: 10/976,162

(22) Filed: Oct. 28, 2004

(51) Int. Cl. A23L 1/212

(52) U.S. Cl. 426/615

(57) ABSTRACT

An animal feedblock is made by injecting steam into a binder to heat the binder, blending the heated binder with a dry ingredients mixture including distillers dried grains or distillers dried grains with solubles to create an ingredients mixture, and compressing the ingredients mixture to form the animal feedblock.

### FIELD OF THE INVENTION

The present invention relates to an animal feed supplement and a method of making the animal feed supplement.

### BACKGROUND

Feedblocks are animal feed supplements for livestock. They are dry or moist blocks of concentrated food that farmers or ranchers give to their grazing animals. Feedblocks provide cost-effective nutritious food that supplements animal grazing. Protein, minerals, and calories are typically available in feedblocks to help livestock grow and remain healthy. A feedblock is soft enough for an animal to eat but hard enough so that it is not eaten too quickly. A useful source of food for feedblocks is the remnants of grain that has been used to make alcohol, e.g., distillers or brewers residue.

A conventional process for making feedblocks includes milling whole corn and combining the milled whole corn with water in a slurry tank. The mixture is processed in a jet cooker, treated with enzymes in a liquefaction vessel, cooled, and fermented with yeast and enzymes in a fermentation vessel. The mixture is treated in a column distillation center to remove ethanol. A centrifuge is used to separate the remaining material into two portions, one that is predominantly liquid containing dissolved/suspended substances (commonly called liquid distillers solubles and thin stillage) and one that is predominantly solids (commonly called wet cake, wet grains, and wet distillers grain). The thin stillage has some of its water removed in an evaporator to make a syrup (commonly called condensed distillers solubles (“CDS”)).

The conventional process dries the wet cake in a drier that is typically a drum drier or a rotary drier. The drier removes the water from the wet cake and converts it into another product called distillers dried grains (“DDG”). The DDG may be combined with the CDS and further dried to produce distillers dried grains with solubles (“DDGS”). The DDG or DDGS is then combined with other feed ingredients and supplements to make a feedblock.

Some patents that relate to feed supplements and methods of making feed supplements are U.S. Pat. No. 4,005,192, U.S. Pat. No. 5,260,089, U.S. Pat. No. 5,264,227, U.S. Pat. No. 6,440,478, and U.S. Pat. No. 6,793,947.

### SUMMARY OF THE INVENTION

An animal feedblock is made by injecting steam into a binder to heat the binder, blending the heated binder with a dry ingredients mixture including distillers dried grains or distillers dried grains with solubles to create an ingredients mixture, and compressing the ingredients mixture to form the animal feedblock. The invention provides the ability to create a low moisture animal feed supplement with an ingredients mixture having a relatively low moisture concentration.

The invention provides, in one aspect, a method for making an animal feed supplement comprising heating a binder using steam, blending the heated binder with distillers dried grains or distillers dried grains with solubles, and compressing the resulting mixture into an animal feedblock.

The invention provides, in one aspect, a method for making an animal feed supplement comprising compressing a mixture of materials that comprises distillers dried grains or distillers dried grains with solubles and steam injected binder into a feedblock that is consumable by a livestock animal.

The invention provides, in one aspect, an animal feedblock comprising a mixture of materials compressed into a solid block, the mixture of materials comprising from about 30 to 75% by weight of distillers dried grains obtained from stillage of fermented whole grain, from about 12 to 50% by weight of molasses injected with steam, and from about 1 to 5.5% by weight of magnesium oxide prior to compression.

### BRIEF DESCRIPTION OF THE DRAWINGS

FIG. 1 depicts a feedblock manufacturing system according to the principles of the present invention.

### DETAILED DESCRIPTION OF A PREFERRED EMBODIMENT

The present invention provides a method for making a feedblock from distillers dried grains (“DDG”) or distillers dried grains with solubles (“DDGS”). The use of DDG or DDGS allows for lower moisture feedblocks to be produced in an efficient and a cost effective manner.

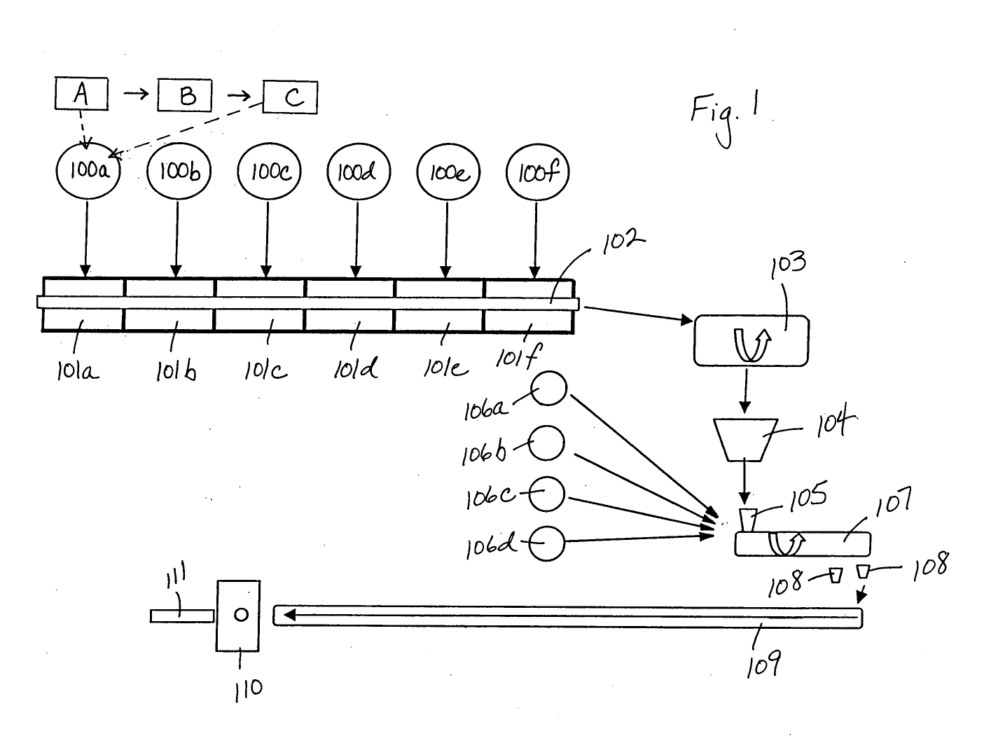

FIG. 1 depicts a preferred embodiment method of the present invention, which is a method of making feedblocks in a continuous manufacturing process. FIG. 1 and the description thereof are illustrative and are not intended to limit the scope of the invention.

Dry ingredients, which may include DDG or DDGS, corn gluten meal, and minerals, are obtained. The dry ingredients may also include consumable products such as soybean meal, wheat products, corn products, natural grains, legumes, and other suitable consumable products. Solubles in syrup including solubles from grains, legumes, wheat, corn, vitamins, or minerals may also be included in the dry ingredients. Preferably, if solubles are included in the dry ingredients, DDGS is used and the solubles are added during the production of DDGS as is well known in the art. Additional ingredients that may be added to the dry ingredients mixture include hardeners or binding agents such as magnesium oxide, calcium oxide, precipitated chalk, ferrous carbonate, calcium hydroxide, magnesium hydroxide, sodium salts of fatty acids, sodium acid pyrophosphate, locust bean gum, karaya gum, and potassium hydroxide. Nutritional supplements such as the macro minerals phosphorous and calcium may also be added to the dry ingredients mixture.

The dry ingredients may be contained in ingredient bins 100a-f as shown in FIG. 1. For example, either DDG or DDGS may be contained in ingredient bin 100a. If DDGS is used, DDG represented by the letter A is combined with CDS represented by the letter B and further dried to produce DDGS represented by the letter C. The DDGS is then placed in ingredient bin 100a. The dry ingredients may be pre-weighed with weigh hoppers 101a-f, respectively, and sent via a conveyor 102 to a mixer 103 for blending of the dry ingredients to create a dry ingredients mixture. The dry ingredients mixture may then be transferred to a surge hopper 104 including a metering device 105 to control the filling of the dry ingredients mixture into a blender 107. The blender 107 is preferably a high speed blender with a steam heated jacket. The metering device 105 ensures a desired amount of the dry ingredients mixture is released from the surge hopper 104 into the blender 107 to maintain a continuous, uninterrupted supply of the dry ingredients mixture flowing from the surge hopper 104.

The dry ingredients mixture preferably flows from the surge hopper 104 through the metering device 105 and the weight and the density of the dry ingredients mixture are determined so as to determine the quantity of binder to be added to the dry ingredients mixture. The binder is preferably molasses and is contained in storage tanks 106a-d. The trace minerals and vitamins are preferably pre-blended with the binder before blending with the dry ingredients mixture in a high speed mixer 107. The dry ingredients mixture, after metering from the surge hopper 104 and the metering device 105, enters a high speed mixer 107 in which the dry ingredients mixture and the binder are introduced and blended together to create an ingredients mixture. Preferably, the ingredients mixture comprises 20 to 50% binder and 50 to 80% dry ingredients mixture. The blending speed is preferably 100 to 1200 revolutions per minute (“rpm”), or more preferably 200 to 1000 rpm, or even more preferably 400 to 800 rpm. Before the binder is blended with the dry ingredients mixture, the binder is preferably pre-heated with steam. The pre-heated binder has a decreased viscosity (an increased flow rate) to assist in uniform blending with the dry ingredients mixture. Preferably, approximately 0.0025 to 1.5000% steam by weight of the pre-heated binder is injected into the binder. The temperature of the pre-heated binder is preferably 50 to 160° F., and more preferably 70 to 140° F., and even more preferably 90 to 120° F. when entering the mixer.

It is recognized that there are many ways in which the binder may be pre-heated with steam. Delivery of the binder to the mixer and injection of steam into the binder may be concurrent. For example, the binder may be pre-heated with steam through direct injection of steam with the binder in a delivery tube in fluid communication with the high speed mixer. When a binder is placed within a heated vessel, the binder will thicken or become granulated in which case the binder will not uniformly blend with the dry ingredients mixture. The use of steam to pre-heat the binder reduces the risk of the binder not uniformly blending with the dry ingredients mixture. In addition, the use of steam to pre-heat the binder reduces the moisture concentration in the resulting feedblock because the moisture in the steam evaporates during blending of the binder with the dry ingredients mixture.

The ingredients mixture resulting from the blended dry ingredients mixture and binder is then dispensed from the mixer 107 into a delivery system that fills containers 108 with the ingredients mixture. Preferably, the ingredients mixture includes 30 to 75% by weight DDG or DDGS, 12 to 50% by weight molasses, and 1 to 5.5% by weight magnesium oxide. It is recognized that these percentages may vary as the percentages of ingredients are dependent upon the desired feedblock formulation. Preferably, the ingredients mixture has a moisture concentration from preferably 10 to 19% by weight, more preferably 12 to 18% by weight, and even more preferably 15 to 17% by weight.

The containers 108 preferably contain 50 to 500 pounds, more preferably 100 to 300 pounds, and even more preferably 150 to 250 pounds of the ingredients mixture. The filled containers 108 are then transferred by conveyor 109 to a press area 110 where the filled containers 108 are placed into a compression chamber for compression of the ingredients mixture in the containers. The ingredients mixture in each container is then compressed, preferably with a hydraulic press, with preferably 500 to 3000 pounds per square inch (“psi”) of pressure, more preferably 1000 to 2500 psi of pressure, and even more preferably 1500 to 2300 psi of pressure. The ingredients mixture is compressed for preferably 5 to 90 seconds, more preferably 10 to 60 seconds, and even more preferably 20 to 40 seconds.

The containers 108 filled with the ingredients mixture are compressed into feedblocks and allowed to cure in cylindrical plastic containers. The feedblocks are cured for preferably 24 hours or more, more preferably 24 to 48 hours, and even more preferably 48 to 96 hours. The curing step allows for any excess moisture to evaporate and increase the hardness of the feedblocks. Preferably, the moisture concentration after the curing step is no more than 1.5% by weight of the feedblock.

After curing, the feedblocks are available for packaging and distribution. The feedblocks may be removed from the containers and re-packaged in a lower cost material such as a shrink-wrap type material configured and arranged to preserve product integrity. Re-packaging the feedblocks results in significant cost savings in product packaging and distribution costs. The packaging material may be plastic, paper, or other suitable material known in the art.

An example of a preferred method includes pre-weighing the dry ingredients in the desired quantities. The dry ingredients (e.g. DDGS, corn gluten meal, magnesium oxide, salt, phosphorus, calcium carbonate, vitamins, and trace minerals) are conveyed to a mixer operating at a mixing speed of 20 to 100 rpm for approximately 30 to 180 seconds to create a dry ingredients mixture. The dry ingredients mixture is transferred to a surge hopper including a metering device. The metering device measures the amount of the dry ingredients mixture transferred into a high speed blender that operates at a mixing speed of 250 to 3000 rpm with a retention time of 30 to 180 seconds. During the high speed blending of the dry ingredients mixture, a steam-injected molasses based product is delivered into the high speed blender for blending with the dry ingredients mixture. The amount of the steam-injected molasses based product delivered into the high speed blender is preferably determined by liquid and steam controls activated by the metering device which reads the rate of dry ingredients mixture entering the high speed blender. The temperature of the blended ingredients mixture is preferably in the range of ambient temperature to 175° F. upon exiting the high speed blender. The blended ingredients mixture is transferred into at least one plastic container ranging in size from 3 to 30 gallons. The filled plastic containers preferably weigh from 25 to 250 pounds and have a moisture content of approximately 10 to 16.15% weight of the blended ingredients mixture prior to compression. The blended ingredients mixture is compressed within the containers with a hydraulic press with 500 to 3000 psi pressure for 5 to 50 seconds. Examples 1-4 provide more specific examples of methods of the present invention.

### EXAMPLE 1

The ingredients listed in Table 1 were pre-weighed in the quantities listed in Table 1. The dry ingredients (including DDGS, magnesium oxide, salt, mono calcium phosphate, and D-grade limestone) were conveyed to a mixer operating at a mixing speed of 20 rpm for approximately 2 minutes to create a mixture. The mixture was transferred to a surge hopper and into a metering device. The metering device measured the amount of mixture transferred into a high speed blender and the amount of binder to be blended with the mixture. The binder, which was a base mix molasses, was heated with steam through direct injection of steam with the binder in a delivery tube to the blender. The binder was heated to approximately 125° F. The blended mixture and binder created a product. The product was transferred into 23-gallon plastic tubs, and the product was compressed within the tubs with a hydraulic press with about 2500 psi for approximately 35 seconds. The moisture content at the time of filling the tubs was about 16.15%. Approximately 120 feedblocks were made and allowed to cure for 2 days. Each of the feedblocks had about 20.39% crude protein (4.95% protein from NPN) and was approximately 200 to 210 pounds. The product composition is listed in Table 2.

TABLE 1
Ingredients

| | Water | Protein | Quantity |
|---|---|---|---|
| Ingredients | (Pounds) | (Pounds) | (Pounds) |
| DDGS | 130.57 | 297.00 | 1,100.00 |
| Base Mix NPN Molasses | 44.00 | 99.00 | 110.00 |
| Magnesium Oxide | | | 75.00 |
| Salt | | | 50.00 |
| Mono Calcium Phosphate | | | 90.00 |
| D-Grade Limestone | | | 70.00 |
| Base Mix Molasses | 120.00 | | 400.00 |
| 79.5 Brix Cane Molasses | | | 105.00 |
| Total | | | 2,000.00 |

TABLE 2
Product Composition

| Ingredient | AS Fed |
|---|---|
| Minimum Crude Protein | 20.39% |
| Maximum Equivalent Protein | 4.95% |
| from NPN | |
| Minimum Crude Fat | 6.01% |
| NE m (Mcal/lb) | 0.62% |
| NE g (Mcal/lb) | 0.42% |
| Crude Fiber Maximum | 5.85% |
| Acid Detergent Fiber | 7.48% |
| Maximum | |
| Neutral Detergent Fiber | 0.00% |
| Maximum | |
| Calcium Minimum | 2.15% |
| Calcium Maximum | 2.36% |
| Phosphorus Minimum | 1.39% |
| Salt (NaCl) Minimum | 2.60% |
| Salt (NaCl) Maximum | 2.60% |
| Magnesium Minimum | 2.37% |
| Potassium Minimum | 2.62% |
| Sulpher Minimum | 0.23% |
| Copper Minimum | 300.00 ppm |
| Selenium Minimum | 4.41 ppm |
| Cobalt Minimum | 3.02 |
| Iodine Minimum | 12.00 |
| Iron Minimum | 208.81 |
| Manganese Minimum | 1001.00 |
| Zinc Minimum | 1000.00 ppm |
| Vitamin A Minimum | 80,000.00 |
| Vitamin D3 Minimum | 10,000.00 |
| Vitamin E Minimum | 100.00 |

### EXAMPLE 2

The ingredients listed in Table 3 were pre-weighed in the quantities listed in Table 3. The dry ingredients (including DDGS, corn gluten meal, magnesium oxide, salt, mono calcium phosphate, and D-grade limestone) were conveyed to a mixer operating at a mixing speed of 20 rpm for approximately 2 minutes to create a mixture. The mixture was transferred to a surge hopper and into a metering device. The metering device measured the amount of mixture transferred into a high speed blender and the amount of binder to be blended with the mixture. The binder, which was a base mix molasses, was heated with steam through direct injection of steam with the binder in a delivery tube to the blender. The binder was heated to approximately 125° F. The blended mixture and binder created a product. The product was transferred into 23-gallon plastic tubs, and the product was compressed within the tubs with a hydraulic press with about 2500 psi for approximately 35 seconds. The moisture content at the time of filling the tubs was about 14.86%. Approximately 120 feedblocks were made and allowed to cure for 2 days. Each of the feedblocks had about 20.21% crude protein (0.00% protein from NPN) and was approximately 200 to 210 pounds. The product composition is listed in Table 4.

TABLE 3
Ingredients

| | Water | Protein | Quantity |
|---|---|---|---|
| Ingredients | (Pounds) | (Pounds) | (Pounds) |
| DDGS | 106.83 | 243.00 | 900.00 |
| Corn Gluten Meal 60% | 24.50 | 147.00 | 245.00 |
| Magnesium Oxide | | | 75.00 |
| Salt | | | 50.00 |
| Mono Calcium Phosphate | | | 85.00 |
| D-Grade Limestone | | | 75.00 |
| Base Mix Molasses | 120.00 | 8.00 | 400.00 |
| 79.5 Brix Cane Molasses | 45.90 | 6.12 | 170.00 |
| Total | | | 2,000.00 |

TABLE 4
Product Composition

| Ingredient | AS Fed |
|---|---|
| Minimum Crude Protein | 20.21% |
| Maximum Equivalent Protein | 0.00% |
| from NPN | |
| Minimum Crude Fat | 5.04% |
| NE m (Mcal/lb) | 0.66 |
| NE g (Mcal/lb) | 0.45 |
| Crude Fiber Maximum | 5.15% |
| Acid Detergent Fiber | 6.88% |
| Maximum | |
| Neutral Detergent Fiber | 1.54% |
| Maximum | |
| Calcium Minimum | 2.28% |
| Calcium Maximum | 2.49% |
| Phosphorus Minimum | 1.31% |
| Salt (NaCl) Minimum | 2.66% |
| Salt (NaCl) Maximum | 2.66% |
| Magnesium Minimum | 2.36% |
| Potassium Minimum | 2.49% |
| Sulpher Minimum | 0.26% |
| Copper Minimum | 304.00 |
| Selenium Minimum | 4.42 |
| Cobalt Minimum | 3.04 |
| Iodine Minimum | 12.00 |
| Iron Minimum | 214.26 |
| Manganese Minimum | 1002.00 |
| Zinc Minimum | 1004.00 |
| Vitamin A Minimum | 80,000.00 |
| Vitamin D3 Minimum | 10,000.00 |
| Vitamin E Minimum | 100.00 |

### EXAMPLE 3

The ingredients listed in Table 5 were pre-weighed in the quantities listed in Table 5. The dry ingredients (including DDGS, corn gluten meal, magnesium oxide, salt, mono calcium phosphate, and D-grade limestone) were conveyed to a mixer operating at a mixing speed of 20 rpm for approximately 2 minutes to create a mixture. The mixture was transferred to a surge hopper and into a metering device. The metering device measured the amount of mixture transferred into a high speed blender and the amount of binder to be blended with the mixture. The binder, which was a base mix molasses, was heated with steam through direct injection of steam with the binder in a delivery tube to the blender. The binder was heated to approximately 125° F. The blended mixture and binder created a product. The product was transferred into 23-gallon plastic tubs, and the product was compressed within the tubs with a hydraulic press with about 2500 psi for approximately 35 seconds. The moisture content at the time of filling the tubs was about 13.50%. Approximately 120 feedblocks were made and allowed to cure for 2 days. Each of the feedblocks had about 30.09% crude protein (0.00% protein from NPN) and was approximately 200 to 210 pounds. The product composition is listed in Table 6.

TABLE 5
Ingredients

| | Water | Protein | Quantity |
|---|---|---|---|
| Ingredients | (Pounds) | (Pounds) | (Pounds) |
| DDGS | 50.45 | 114.75 | 425.00 |
| Corn Gluten Meal 60% | 79.50 | 477.00 | 795.00 |
| Magnesium Oxide | | | 75.00 |
| Salt | | | 50.00 |
| Mono Calcium Phosphate | | | 90.00 |
| D-Grade Limestone | | | 65.00 |
| Fat Base QLF | 20.00 | | 100.00 |
| Base Mix Molasses | 120.00 | 8.00 | 400.00 |
| 79.5 Brix Cane Molasses | | | |
| Total | | | 2,000.00 |

TABLE 6
Product Composition

| Ingredient | AS Fed |
|---|---|
| Minimum Crude Protein | 30.09% |
| Maximum Equivalent Protein | 0.00% |
| from NPN | |
| Minimum Crude Fat | 5.22% |
| NE m (Mcal/lb) | 0.71 |
| NE g (Mcal/lb) | 0.49 |
| Crude Fiber Maximum | 3.45% |
| Acid Detergent Fiber | 5.36% |
| Maximum | |
| Neutral Detergent Fiber | 5.01% |
| Maximum | |
| Calcium Minimum | 2.19% |
| Calcium Maximum | 2.40% |
| Phosphorus Minimum | 1.27% |
| Salt (NaCl) Minimum | 2.50% |
| Salt (NaCl) Maximum | 2.50% |
| Magnesium Minimum | 2.26% |
| Potassium Minimum | 2.28% |
| Sulpher Minimum | 0.20% |
| Copper Minimum | 309.00 |
| Selenium Minimum | 4.40 |
| Cobalt Minimum | 3.00 |
| Iodine Minimum | 12.00 |
| Iron Minimum | 200.00 |
| Manganese Minimum | 1000.00 |
| Zinc Minimum | 1012.00 |
| Vitamin A Minimum | 80,000.00 |
| Vitamin D3 Minimum | 10,000.00 |
| Vitamin E Minimum | 100.00 |

### EXAMPLE 4

The ingredients listed in Table 7 were pre-weighed in the quantities listed in Table 7. The dry ingredients (including DDGS, corn gluten meal, magnesium oxide, salt, mono calcium phosphate, and D-grade limestone) were conveyed to a mixer operating at a mixing speed of 20 rpm for approximately 2 minutes to create a mixture. The mixture was transferred to a surge hopper and into a metering device. The metering device measured the amount of mixture transferred into a high speed blender and the amount of binder to be blended with the mixture. The binder, which was a base mix molasses, was heated with steam through direct injection of steam with the binder in a delivery tube to the blender. The binder was heated to approximately 125° F. The blended mixture and binder created a product. The product was transferred into 23-gallon plastic tubs, and the product was compressed within the tubs with a hydraulic press with about 2500 psi for approximately 35 seconds. The moisture content at the time of filling the tubs was about 17.28%. Approximately 120 feedblocks were made and allowed to cure for 2 days. Each of the feedblocks had about 30.00% crude protein (11.25% protein from NPN) and was approximately 200 to 210 pounds. The product composition is listed in Table 8.

TABLE 7
Ingredients

| | Water | Protein | Quantity |
|---|---|---|---|
| Ingredients | (Pounds) | (Pounds) | (Pounds) |
| DDGS | 105.64 | 240.30 | 890.00 |
| Corn Gluten Meal 60% | 20.00 | 120.00 | 200.00 |
| Base Mix NPN Molasses | 100.00 | 225.00 | 250.00 |
| Magnesium Oxide | | | 75.00 |
| Salt | | | 40.00 |
| Mono Calcium Phosphate | | | 85.00 |
| D-Grade Limestone | | | 60.00 |
| Base Mix Molasses | 120.00 | 8.00 | 400.00 |
| 79.5 Brix Cane Molasses | | | |
| Total | | | 2,000.00 |

TABLE 8
Product Composition

| Ingredient | AS Fed |
|---|---|
| Minimum Crude Protein | 30.00% |
| Maximum Equivalent Protein | 11.25% |
| from NPN | |
| Minimum Crude Fat | 4.96% |
| NE m (Mcal/lb) | 0.58 |
| NE g (Mcal/lb) | 0.40 |
| Crude Fiber Maximum | 5.03% |
| Acid Detergent Fiber | 6.68% |
| Maximum | |
| Neutral Detergent Fiber | 1.26% |
| Maximum | |
| Calcium Minimum | 1.92% |
| Calcium Maximum | 2.13% |
| Phosphorus Minimum | 1.29% |
| Salt (NaCl) Minimum | 2.00% |
| Salt (NaCl) Maximum | 2.00% |
| Magnesium Minimum | 2.32% |
| Potassium Minimum | 2.59% |
| Sulpher Minimum | 0.20% |
| Copper Minimum | 302.00 |
| Selenium Minimum | 4.40 |
| Cobalt Minimum | 3.00 |
| Iodine Minimum | 12.00 |
| Iron Minimum | 200.00 |
| Manganese Minimum | 1000.00 |
| Zinc Minimum | 1003.00 |
| Vitamin A Minimum | 80,000.00 |
| Vitamin D3 Minimum | 10,000.00 |
| Vitamin B Minimum | 100.00 |

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of making an animal feed supplement, comprising:
a) heating a binder using steam;
b) blending the heated binder with distillers dried grains or distillers dried grains with solubles; and
c) compressing the resulting mixture into an animal feedblock.

2. The method of claim 1, wherein the resulting mixture includes 30 to 75% distillers dried grains.

3. The method of claim 2, wherein the resulting mixture includes 12 to 50% molasses and 1 to 5.5% magnesium oxide.

4. The method of claim 1, further comprising mixing the distillers dried grains with condensed distillers solubles and drying the mixture of distillers dried grains and condensed distillers solubles to produce distillers dried grains with solubles prior to blending the mixture including distillers dried grains with solubles with the heated binder.

5. The method of claim 4, wherein the resulting mixture includes 30 to 75% distillers dried grains with solubles.

6. The method of claim 5, wherein the resulting mixture includes 12 to 50% molasses and 1 to 5.5% magnesium oxide.

7. The method of claim 1, wherein the binder comprises molasses.

8. The method of claim 1, wherein the binder is injected with 0.0025 to 1.5000% steam.

9. The method of claim 1, wherein the binder is heated to 50 to 160° F.

10. The method of claim 1, wherein the resulting mixture has a moisture concentration of 10 to 19% by weight of the product prior to compression.

11. The method of claim 1, further comprising blending the heated binder with dry ingredients comprising distillers dried grains or distillers dried grains with solubles, the resulting mixture comprising 20 to 50% binder and 50 to 80% dry ingredients.

12. A feedblock made by the method of claim 1.

13. A method of making an animal feed supplement, comprising:
compressing a mixture of materials that comprises distillers dried grains or distillers dried grains with solubles and steam injected binder into a feedblock that is consumable by a livestock animal.

14. The method of claim 13, wherein the feedblock includes 30 to 75% distillers dried grains, 12 to 50% molasses, and 1 to 5.5% magnesium oxide.

15. The method of claim 13, further comprising mixing the distillers dried grains with condensed distillers solubles and drying the mixture of distillers dried grains and condensed distillers solubles to produce distillers dried grains with solubles prior to compressing the mixture.

16. The method of claim 15, wherein the feedblock includes 30 to 75% distillers dried grains with solubles, 12 to 50% molasses, and 1 to 5.5% magnesium oxide.

17. The method of claim 13, wherein the binder comprises molasses.

18. The method of claim 13, wherein the binder is injected with 0.0025 to 1.5000% steam.

19. The method of claim 13, wherein the binder is heated to 50 to 160° F. with steam.

20. The method of claim 13, wherein the mixture has a moisture concentration of 10 to 19% by weight of the mixture prior to compression.

21. A feedblock made by the method of claim 13.

22. An animal feedblock comprising a mixture of materials compressed into a solid block, the mixture of materials comprising from about 30 to 75% by weight of distillers dried grains obtained from stillage of fermented whole grain, from about 12 to 50% by weight of molasses injected with steam, and from about 1 to 5.5% by weight of magnesium oxide prior to compression.

23. The animal feedblock of claim 22, wherein the molasses is injected with 0.0025 to 1.5000% steam.

24. The animal feedblock of claim 22, wherein the injected molasses is 50 to 160° F.

25. The animal feedblock of claim 22, wherein the distillers dried grains is mixed with condensed distillers solubles and dried to produce distillers dried grains with solubles prior to compressing the mixture of materials into the solid block.

26. The animal feedblock of claim 22, wherein the mixture of materials has a moisture concentration of 10 to 19% by weight prior to compression.
